(19) United States
(12) Patent Application Publication
(10) Pub. No.: US 2025/0148411 A1
(43) Pub. Date: May 8, 2025

(54) Data Ingestion Pipeline for Bucketized Search and Selection

(71) Applicant: Uber Technologies, Inc., San Francisco, CA (US)

(72) Inventors: Atul Anand, Bengaluru (IN); Janini Narayanan, San Carlos, CA (US); Karthikeyan Ramasamy, Fremont, CA (US); Juan-Pablo Cristian Silva Peña, Santiago (CL)

(21) Appl. No.: 18/504,847

(22) Filed: Nov. 8, 2023

(51) Int. Cl. G06Q 10/0836

(52) U.S. Cl. CPC G06Q 10/0836

(57) ABSTRACT

Systems and method for data ingestion pipeline for bucketized search and selection. The method includes accessing a data structure including a number of delivery zones, merchants, and associated travel durations. A bucketized index data structure can be generated including travel duration buckets and associated merchants. The method includes obtaining a service order request including a drop-off location. The method includes determining a cross-bucket subset of merchants based at least in part on the index data structure and drop-off location. The method includes transmitting data including instructions that, when executed by a client device, cause the cross-bucket subset of merchants to be provided for display via an interface of the client device.

### FIELD

The present disclosure generally relates to a data ingestion pipeline for bucketized selection, ranking, or search of merchants in a geographic area. More particularly, the present disclosure is related to features for generating a bucketized data structure of delivery zones, deliverable merchants, and estimated times of arrival associated with the respective merchant-delivery zone groups in order to reduce real-time processing required for selection, ranking, or search of merchants.

### BACKGROUND

Delivery services, such as food delivery services, allow a user to request a service that may be performed by a vehicle or courier. For instance, a user may request, through a food delivery service application, a food delivery service having a pick-up location, a drop-off location, and an item for delivery. A courier can be assigned to perform the food delivery service for the user. This can include transporting the delivery of the item to the drop-off location.

### SUMMARY

Aspects and advantages of embodiments of the present disclosure will be set forth in part in the following description, or may be learned from the description, or may be learned through practice of the embodiments.

One aspect of the present disclosure is directed to a computing system. The computing system includes one or more processors and one or more tangible, non-transitory, computer readable media that store instructions that are executable by the one or more processors to cause the computing system to perform operations. The operations include accessing a data structure including a plurality of delivery zones, a plurality of merchants, and a travel duration associated with each respective delivery zone of the plurality of delivery zones. The operations include generating, based at least in part on the accessed data structure, an index data structure including for each delivery zone of the plurality of delivery zones: (i) a first travel duration bucket; (ii) a second travel duration bucket; and (iii) one or more merchants associated with the first travel duration bucket and one or more merchants associated with the second travel duration bucket. The operations include accessing data associated with a delivery service request including at least a drop-off location. The operations include responsive to accessing the data associated with the delivery service request: (i) determining a first delivery zone of the plurality of delivery zones including the drop-off location; and (ii) parsing the index data structure to determine one or more merchants in a first travel duration bucket associated with the first delivery zone and one or more merchants in a second travel duration bucket associated with the first delivery zone. The first travel duration bucket and second travel duration bucket are non-overlapping sets of merchants. The operations include selecting a cross-bucket subset of merchants including a first subset of merchants from the first travel duration bucket and a second subset of merchants from the second travel duration bucket. The operations include transmitting data including instructions that, when executed by a client device, cause the cross-bucket subset of merchants to be provided for display via an interface of the client device.

Another Example aspect of the present disclosure is directed to a computer-implemented method. The method includes accessing a data structure including a plurality of delivery zones, a plurality of merchants, and a travel duration associated with each respective delivery zone of the plurality of delivery zones. The method includes generating, based at least in part on the accessed data structure, an index data structure including for each delivery zone of the plurality of delivery zones: (i) a first travel duration bucket; (ii) a second travel duration bucket; and (iii) one or more merchants associated with the first travel duration bucket and one or more merchants associated with the second travel duration bucket. The method includes accessing data associated with a delivery service request including at least a drop-off location. The method includes responsive to accessing the data associated with the delivery service request: (i) determining a first delivery zone of the plurality of delivery zones including the drop-off location; and (ii) parsing the index data structure to determine one or more merchants in a first travel duration bucket associated with the first delivery zone and one or more merchants in a second travel duration bucket associated with the first delivery zone. The first travel duration bucket and second travel duration bucket are non-overlapping sets of merchants. The method includes selecting a cross-bucket subset of merchants including a first subset of merchants from the first travel duration bucket and a second subset of merchants from the second travel duration bucket. The method includes transmitting data including instructions that, when executed by a client device, cause the cross-bucket subset of merchants to be provided for display via an interface of the client device.

Yet another example aspect of the present disclosure is directed to one or more non-transitory computer readable media storing instructions that are executable by one or more processors to perform operations. The operations include accessing a data structure including a plurality of delivery zones, a plurality of merchants, and a travel duration associated with each respective delivery zone of the plurality of delivery zones. The operations include generating, based at least in part on the accessed data structure, an index data structure including for each delivery zone of the plurality of delivery zones: (i) a first travel duration bucket; (ii) a second travel duration bucket; and (iii) one or more merchants associated with the first travel duration bucket and one or more merchants associated with the second travel duration bucket. The operations include accessing data associated with a delivery service request including at least a drop-off location. The operations include responsive to accessing the data associated with the delivery service request: (i) determining a first delivery zone of the plurality of delivery zones including the drop-off location; and (ii) parsing the index data structure to determine one or more merchants in a first travel duration bucket associated with the first delivery zone and one or more merchants in a second travel duration bucket associated with the first delivery zone. The first travel duration bucket and second travel duration bucket are non-overlapping sets of merchants. The operations include selecting a cross-bucket subset of merchants including a first subset of merchants from the first travel duration bucket and a second subset of merchants from the second travel duration bucket. The operations include transmitting data including instructions that, when executed by a client device, cause the cross-bucket subset of merchants to be provided for display via an interface of the client device.

### BRIEF DESCRIPTION OF THE DRAWINGS

Detailed discussion of embodiments directed to one of ordinary skill in the art are set forth in the specification, which makes reference to the appended figures, in which:

FIG. 1 depicts a block diagram of an example system for generating merchant buckets for ranking merchants to be presented for user selection according to aspects of the present disclosure.

FIG. 2 depicts a block diagram of a process flow associated with fulfilling an order request according to aspects of the present disclosure.

FIG. 3 depicts a block diagram of a process flow associated with generating merchant-zone pairs and travel duration buckets according to aspects of the present disclosure.

FIG. 4A-FIG. 4C depict examples of travel duration bucket generation according to aspects of the present disclosure.

FIG. 5A-FIG. 5B depict examples of travel duration bucket generation according to aspects of the present disclosure.

FIG. 6A-FIG. 6B depict examples of travel duration bucket generation according to aspects of the present disclosure.

FIG. 7 depicts an example method according to example embodiments of the present disclosure.

FIG. 8 and FIG. 9 depict block diagrams of example systems according to example embodiments of the present disclosure.

### DETAILED DESCRIPTION

Generally, the present disclosure is directed to improved systems and methods for data storage and ingestion to reduce real-time processing required for selection, ranking, or search of merchants. More particularly, aspects of the present disclosure relate to pre-processing merchant data offline to generate a bucketized data structure of delivery zones, deliverable merchants, and travel durations associated with the respective merchant-delivery zone groups. The merchant-delivery zone groups can be divided into buckets based at least in part on an estimated duration between the merchant location and the delivery zone location. The merchants can be mapped to delivery zones based at least in part on factors including a travel duration (e.g., temporal, or physical distance). Upon receipt of data indicating a user has launched a delivery service application, the computing system can utilize the bucketized data structure to select one or more candidate merchants to present to the user via an interface displaying the delivery service application.

The present disclosure can additionally provide for selecting a cross-bucket subgroup of merchants to be provided for display via the user interface. For instance, a subgroup of merchants can be selected from a number of buckets of deliverable merchants based at least in part on a selection criterion such a percentage or score-based criteria. The buckets of deliverable merchants can be non-overlapping (e.g., disjoint) such that a list of merchants in a first bucket will not contain any of the same merchants in a list of merchants in a second bucket.

Additionally, the method can include determining an order to display the candidate merchants via the interface. For instance, the merchants can be ranked by a merchant ranking model. The merchant ranking model can ingest data associated with the delivery service request and the merchants to select a number of merchants to display as candidate merchants.

The method can include facilitating the performance of the delivery service request. For instance, the method can include providing near real-time updates on the progress of the order.

The present disclosure can provide for a number of technical benefits. For instance, the present disclosure allows for increasing a number of candidate merchants that can be selected and ranked while reducing latency. The latency and bandwidth use are reduced by regularly generating the bucketized data structure offline to be used in the merchant selection and ranking process. In this way, the computing system does not have to compute in real-time (or near real-time) estimated travel durations between a delivery location associated with an order and a number of merchants. Performing these calculations offline ahead of time greatly reduces latency for the food delivery service and results in less utilization of computing resources because calculations can be performed for a specific geography by one processing system at a regular cadence instead of being performed on each user-device at the time of order request initiation. Thus, the present disclosure provides for numerous technical effects and benefits that improve the functionality of a computing system (and its associated hardware) to deliver the operations and techniques described herein.

For example, the following describes the technology of the disclosure within the context of a server computing system for example purposes only. As described herein, the technology described herein is not limited to a server computing device and can be implemented for instance, on a user device or other computing device associated with a user or merchant or other computing systems.

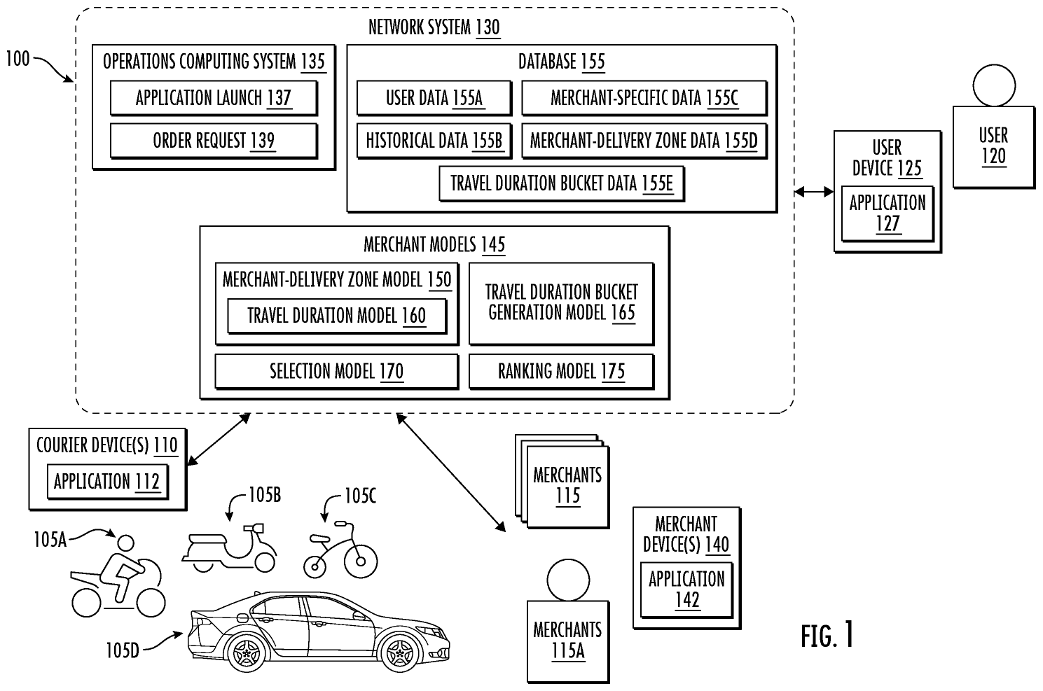

FIG. 1 depicts a block diagram of an example system 100 for a data ingestion pipeline for bucketized selection, ranking, or search of merchants and delivery zones according to aspects of the present disclosure. As illustrated, FIG. 1 shows a system 100 that can include one or more vehicles 105A-105D (e.g., a car, scooter, motorcycle, bicycle) and one or more courier devices 110 that can be associated with one or more couriers. In some examples, the one or more couriers are humans. In some examples, the couriers can be non-human (e.g., vehicle, autonomous vehicle, autonomous robot). The one or more couriers and the one or more courier devices 110 (e.g., an onboard tablet, a mobile device of a courier) can be associated with the one or more vehicles 105A-105D. The courier device(s) 110 can include a software application 112 associated with the food delivery service entity, which can run on the courier device(s) 110. The computing system 100 can include one or more merchants 115. The merchants 115 can receive data indicative of a food delivery service request from a user 120.

For example, the user 120 can initiate a delivery service session (e.g., via a software application such as application 127). In some instances, the user 120 can submit a request through a user device 125 associated with the user (e.g., via a software application such as application 127). A network system 130 can include a computing system associated with a service entity that can facilitate a request for services from user 120. An operations computing system 135 associated with the food delivery service entity can facilitate a request for services from user 120. For example, the user 120 can submit a food delivery request through a user device 125 associated with the user 120 (e.g., via a software application such as application 127). Operations computing system 135 can receive data indicative of an application launch 137 or an order request 139 from a user device 125. Data indicative of application launch 137 can be transmitted automatically in response to determining that the service application 127 has launched (e.g., been opened or otherwise initiated on user device 125). The operations computing system 135 can send data indicative of order request 139 to a merchant device 140 associated with a merchant 115A (e.g., via a software application such as application 142).

The network system 130 (e.g., including operations computing system 135) can access or store one or more merchant models 145 and databases 155. For instance, the databases 155. The data stored in databases 155 can include user data 155A, historical data 155B, merchant-specific data 155C, merchant-delivery zone data 155D, or travel duration bucket data 155E. The merchant models 145 can use data stored in databases 155 or populate databases 155 with data generated by the merchant models 145. The use and generation of such data is discussed herein.

Merchant-delivery zone model 150 can utilize data indicative of the number of merchants 115 to generate a bucketized data structure. The operations computing system 135 can receive data indicative of a number of merchants 115. For instance, the data can include merchant-specific data 155C such as merchant location, inventory, store type, cuisine type, average time to shop, or other relevant data. By way of example, merchant-delivery zone model 150 can use merchant-specific data 155C and travel duration model 160 (e.g., isochrone model, haversine model, merchant's delivery zone mapping model) to determine a travel duration between each respective merchant of the number of merchants 115 and various predefined delivery zones associated with a geographic area. Travel durations can include temporal durations or physical distance durations (e.g., haversine distance). In some instances, travel durations can be determined at the point a merchant on boards to the delivery service and can be updated at a regular or irregular cadence. The travel durations, if temporal based, can vary depending on the time of day, day of week, season, etc.

The predefined delivery zones associated with a geographic area can be determined in a number of ways. For instance, in one implementation, the network system 130 can generate a set of delivery zones within each geographic area within which the network system 130 provides delivery services (e.g., each city, county, state). The geographic area can be divided into delivery zones which can be in a polygon shape such as a hexagon. In some implementations the delivery zones can be blocks, streets, or other subgroups of locations (e.g., similar to the merchant's delivery zones used in isochrone generation).

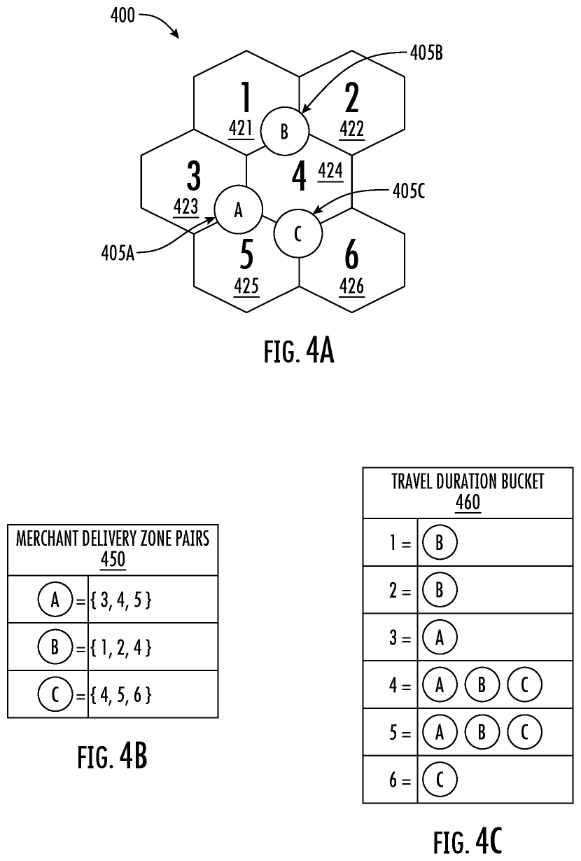

Groups of delivery zones that are capable of being reached within a range of travel durations (e.g., delivery zones that can be reached within 15 minutes of a merchant) can be stored as groups. For instance, the groups can be determined using filtering criteria. The filtering criteria can include a range of travel durations. For instance, if there are five delivery zones in a geographic area that can be reached within a 15-minute travel duration, the five delivery zones can be stored in a first travel duration bucket associated with the merchant. An example merchant-delivery zone data 155D structure is described with regard to FIG. 4. The pairs of merchants, travel durations, and delivery zones within such travel durations can be stored in one or more databases 155 as merchant-delivery zone data 155D.

The merchant-delivery zone data 155D generated by the merchant-delivery zone model 150 can be utilized by travel duration bucket generation model 165 to generate travel duration bucket data 155E. Travel duration bucket generation model 165 can ingest the merchant-delivery zone data 155D including a data structure (e.g., table or list) of delivery zones that are within certain travel durations (e.g., travel time, distance) of each given merchant. The travel duration bucket generation model 165 can generate an index (e.g., in some implementations described as a “reverse index”) which, for each delivery zone, stores a list of merchants that are within certain travel durations of the delivery zones. The generated index can be stored in one or more databases 155 as travel duration bucket data 155E.

The merchants 115 can be selected or ranked by merchant ranking model 175. For instance, responsive to obtaining data indicative of an application launch 137 or data associated with a user searching for recommendations within a specified travel duration, the merchants can be selected using selection model 170 or ranked using ranking model 175. Selection model 170 can utilize travel duration bucket data 155E to generate a selection of a subset of merchants. In some implementations, selection model 170 and ranking model 175 can be the same model. In some implementations, selection model 170 and ranking model 175 can be distinct models.

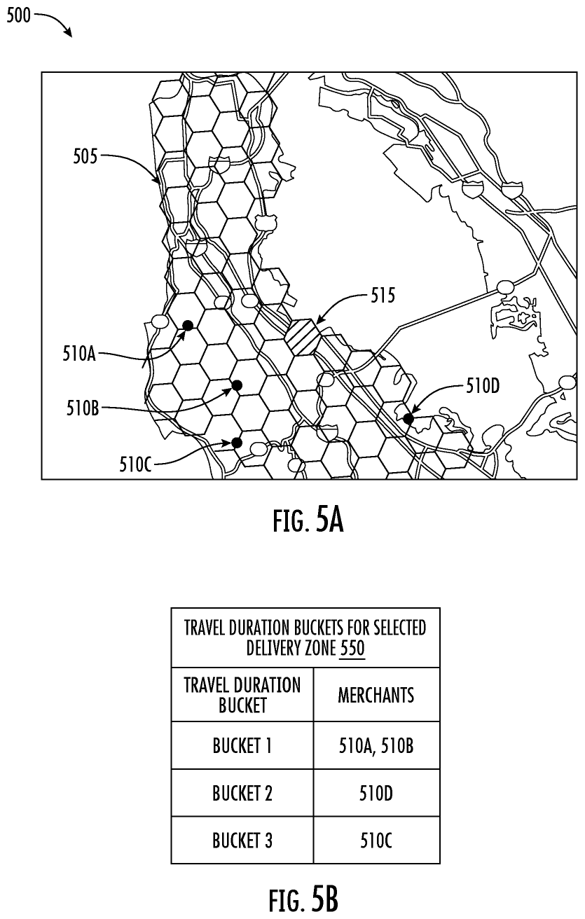

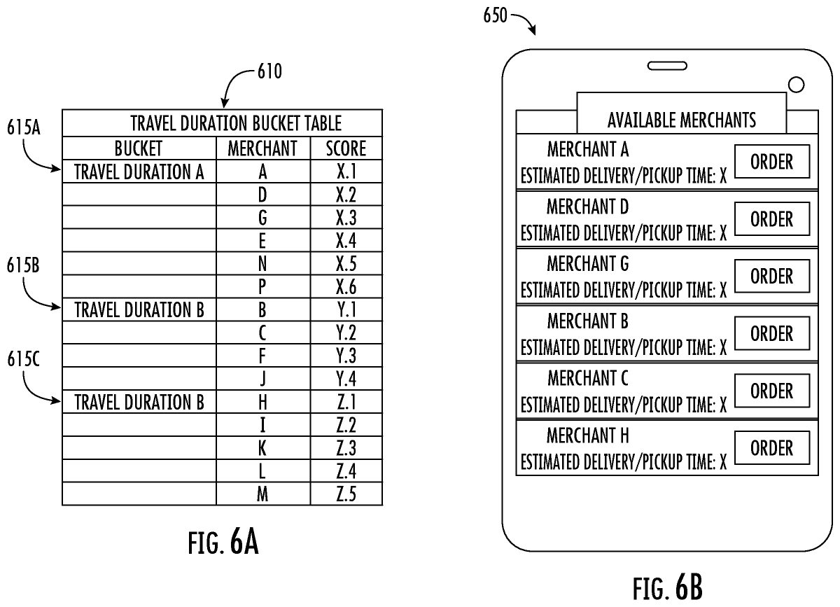

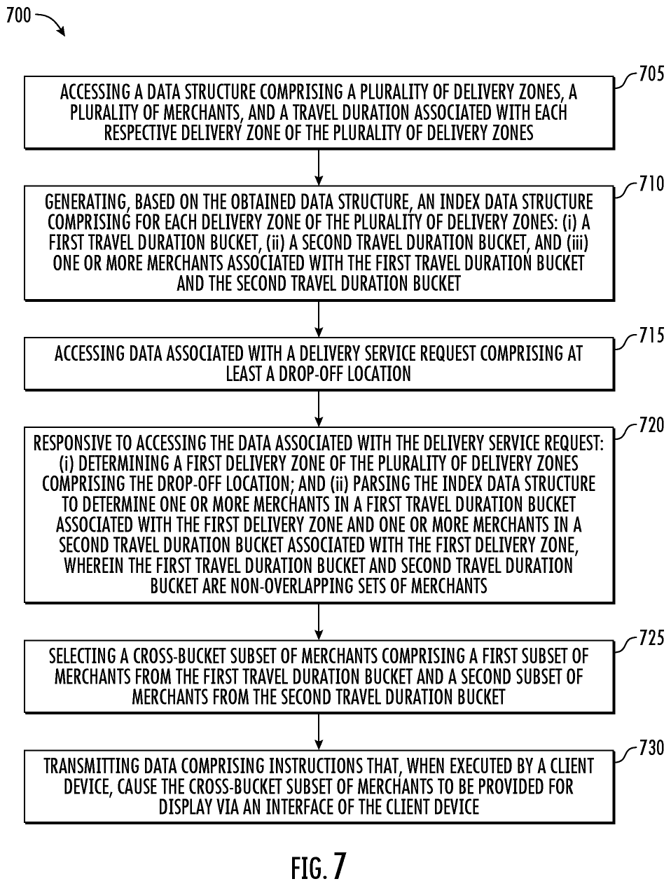

Ranking model 175 can use user data 155A, historical data 155B, or merchant-specific data 155C in ranking the subset of merchants. The subset of merchants can include a cross-bucket subset of merchants selected from a number of buckets of non-overlapping groups of merchants (e.g., disjoint group). The selection of a cross-bucket subset of merchants will be described in further detail with regard to FIG. 5, FIG. 6, and FIG. 7.

User data 155A can include data associated with user 120. Historical data 155B can include data associated with user 120, data associated with merchants 115, or data associated with couriers. Other relevant data can be utilized by selection model 170 or ranking model 175. For instance, other relevant data can include system-level data associated with a number of users or expected demand.

Merchant-specific data 155C can include location, cuisine type, customer reviews and ratings, preparation time, food options, menu, payment options, certifications, dietary information, operating hours, contact information, name, and more for merchant ranking. In some embodiments, merchant-specific data 155C can be indicative of a merchant 115A accepting a food preparation request (e.g., food being prepared, estimated preparation time).

The operations computing system 135 can transmit data including instructions that when executed by user device 125, cause a user interface associated with application 127 to display the ranked merchants. The operations computing system 135 can obtain user data indicative of selection of one or more items from one or more merchants as part of order request 139.

The operations computing system 135 can generate data indicative of an order request 139 (e.g., estimated time of departure, estimated time of arrival, estimated preparation time, real-time updates on order preparation, real-time updates on order location). The operations computing system 135 can provide data for display on a user device 125 (e.g., via application 127) indicative of updates on the order request 139. For example, an update can include an update about what stage of delivery the primary order is in (e.g., preparation, pick-up by courier, courier in route, approaching delivery, delivered).

An operations computing system 135 associated with the service entity can receive an order request 139 from the user device 125. The operations computing system 135 can send a request to a courier device 110 associated with a courier (e.g., via a software application 112) for the courier to perform the requested primary order request service. The courier can be associated with the vehicle (e.g., vehicle 105A-105D).

The operations computing system 135 can communicate data indicative of the delivery service assignment to a courier (e.g., a human courier, an autonomous vehicle courier, an autonomous robot courier). For instance, the operations computing system 135 can send a request to the courier device 110 of the courier. The request (e.g., for the courier to accept the delivery service assignment) can be communicated to the courier via the software application 112 running on the courier device 110 associated with the courier. Additionally, or alternatively, the operations computing system 135 can send a request to a courier device(s) 110 (e.g., a tablet stored onboard the vehicle) of at least one of vehicles 105A-105D. The request (for the courier to accept the delivery service assignment) can be communicated to the courier via the software application 112 running on a courier device 110. The courier can provide user input to the courier device 110 (e.g., via the software application 112) to accept or decline the vehicle service assignment. In some examples, user input can be provided directly into a service application. Additionally, or alternatively, user input can be provided via an application programing interface (API) or a third-party application. Data indicative of the acceptance or rejection of the request can be provided to the operations computing system 135.

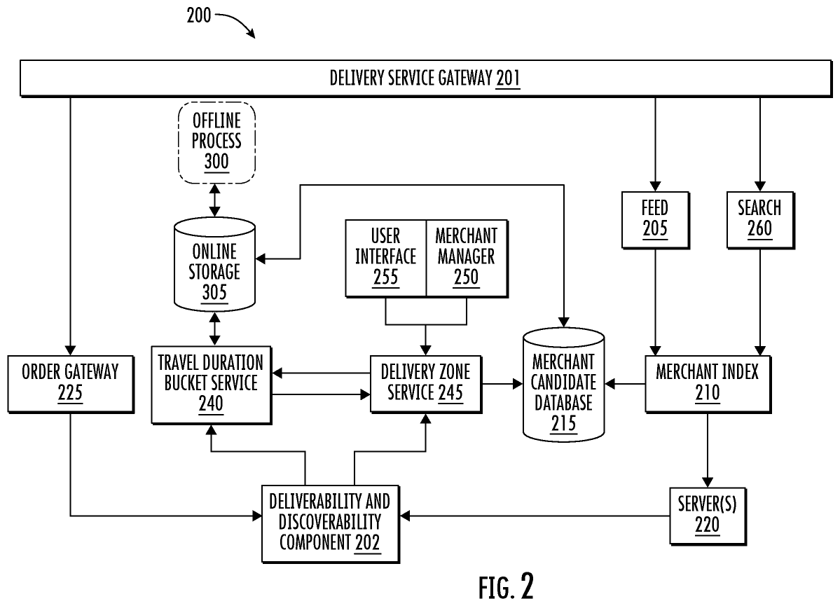

The network system 130 can include a number of potential system architecture designs. FIG. 2 depicts an example system architecture 200 associated with a process flow for fulfilling an order request according to aspects of the present disclosure. The architecture can include a delivery service gateway 201 that receives data indicative of an application launch or a request for delivery service from a user device (e.g., user device 125, client device). Upon receipt of the data indicative of an application launch, or request for delivery service, the system can send a request to a feed component 205, search component 260, or an order gateway 225. Order gateway 225 can communicate directly with deliverability and discoverability component 202. Feed component 205 can generate a feed for display on a user device including one or more menu items or merchant selection options. Search component 260 can generate a search result interface responsive to receipt of a search query from the user including one or more menu items or merchant selection options responsive to the search query. The merchant selection options, or menu items can be stored in merchant index 210. Merchant index 210 can retrieve one or more candidate merchants from merchant candidate database 215. Merchant index 210 can communicate with one or more servers 220 to determine a rank for each respective merchant of the one or more candidate merchants. The servers 220 can determine a rank for each merchant based at least in part on the deliverability or discoverability of each merchant which can be determined by the deliverability and discoverability component 202.

The deliverability and discoverability component 202 can determine deliverability based at least in part on travel duration buckets stored in travel duration bucket service 240 (e.g., groups of delivery zones, travel durations, and merchants) and delivery zone service 245 (e.g., associated with each merchant). Travel duration bucket service 240 can be generated via offline process 300 and stored in online storage 305. Delivery zone service 245 can be populated based in part on merchant manager 250. Merchant manager 250 can include a user interface 255 which can be configured to obtain user input via selectable elements. The user input can be obtained by a user associated with the service provider to manage merchants (e.g., via merchant manager 250).

The deliverability and discoverability component 202 can be used to determine if a menu item associated with a merchant (e.g., one of merchants 115) is deliverable or discoverable to a user (e.g., user 120). A service provider (e.g., delivery service provider associated with operations computing system 135) can set parameters used to determine the deliverability or discoverability of a menu item associated with a merchant. The deliverability and discoverability component 202 can be used to confirm deliverability or discoverability at various points in the merchant selection, ranking, and order processing processes. For instance, deliverability can be associated with merchants that have menu items which can be delivered to a user within a deliverable zone. For instance, discoverability can include merchants which are discoverable for pick-up orders but are not currently available for delivery. In some instances, a merchant can be both discoverable and deliverable. In some instances, a merchant can be discoverable and not deliverable.

The right portion of system architecture 200 depicts the process of a service application launching and generation or display of a feed or search interface including menu item(s) or merchant selection option(s) to be provided for display via a user device (e.g., user device 125). For example, feed component 205 can handle feed generation and ranking based at least in part on the receipt of data indicative of an application launch on a user device (e.g., application 127 on user device 125). The feed component 205 can relay information to a merchant index 210 which can include proximate deliverable merchants based at least in part on a location associated with a delivery service request (e.g., a user location). Merchant index 210 can retrieve one or more candidate merchants from a merchant candidate database 215.

In some instances, feed component 205 can surface merchants based at least in part on data obtained from delivery zone service 245 or travel duration bucket service 240. For instance, a user can have a default range or can provide selection or input indicative of a range of travel durations of which to show merchants. The travel duration range can be a temporal range or physical distance. For instance, the travel duration range can be a unit of time determined using isochrones, a physical haversine or travel mileage distance, or any other distance determined via a formula or algorithm. In some instances, the range can be a default range set by the computing system (e.g., network system 130). Additionally, or alternatively, a user can provide or be prompted to provide a range.

For example, a user can provide input indicative of a desire to be displayed merchants that are deliverable within a thirty-minute, fifty-minute, or any other temporal duration. For instance, the temporal duration can be the travel duration. This input can be accessed by the computing system (e.g., via delivery service gateway 201.

Responsive to obtaining the user input indicative of the range of travel durations or the launching of an application, the computing system can select a subset of merchants to be ranked and provided for display (e.g., via application 127 on user device 125). The manner in which the subset of merchants is selected and ranked will be discussed in further detail with regard to FIG. 6 and FIG. 7.

Search component 260 can handle search interface generation and ranking based at least in part on the receipt of data indicative of a search query for an item or merchant on a user device (e.g., application 127 on user device 125). The search component 260 can relay information to merchant index 210 which can include proximate deliverable or discoverable merchants based at least in part on a location associated with the service request (e.g., a user location). Merchant index 210 can retrieve one or more candidate merchants from merchant candidate database 215.

The merchant candidate database 215 can call to one or more servers 220 which contain metadata for the one or more candidate merchants. The one or more servers 220 can relay the metadata for the one or more candidate merchants to the merchant index 210. The merchant index 210 can communicate with the one or more servers 220 to determine a rank for each respective merchant of the one or more merchants. In some instances, the one or more servers 220 can communicate with the deliverability and discoverability component 202. In some embodiments, it can be determined that a merchant is undeliverable by the deliverability and discoverability component 202. In such instances, the undeliverable merchant can be ranked at the bottom or excluded from a list of one or more candidate merchants. In some instances, it can be determined that a merchant is discoverable by the deliverability and discoverability component 202. In such instances, the discoverable merchant can be displayed if a user has indicated (e.g., via preferences, selection of a setting) that the user is willing to pick up an item opposed to solely order delivery.

Turning to the left side of system architecture 200, the system can obtain data indicative of an order checkout (e.g., via delivery service gateway 201). For example, the system can obtain data indicative of user input via a user interface of a user device (e.g., user device 125). The user input can be indicative of a user selection of a “checkout” option following the creation (or filling) of a cart. The checkout function can be facilitated via the order gateway 225. Upon receipt of user input indicative of selection of a “checkout” option, the system can perform a checking operation to confirm the deliverability of the one or more merchants associated with the cart based at least in part on data obtained from the deliverability and discoverability component 202. In some embodiments data can be obtained that is indicative of a user launching a delivery service application (e.g., application 127). The system can provide for display a selectable user interface clement indicating that a user can select the user interface element to “reorder” a past menu item. Upon user selection of “reorder” a past menu item, the system can check with the deliverability and discoverability component 202 to determine that the merchant associated with the reordered menu item is a deliverable merchant (e.g., for the current time, current location of a user, current courier supply).

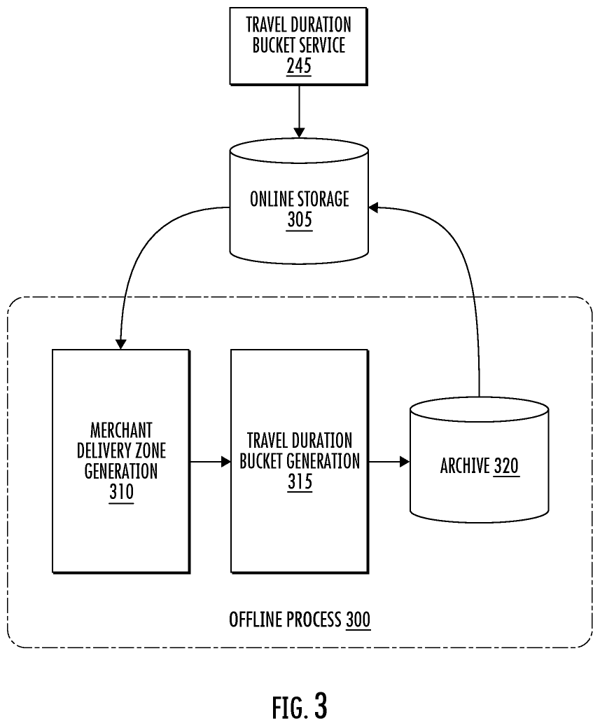

The system can include an offline process 300 which is discussed further in regard to FIG. 3. The offline process 300 can be used to generate or validate the data obtained from travel duration bucket service 240, delivery zone service 245, or merchant candidate database 215. In some instances, offline process 300 is used to generate the travel duration bucket index of merchants which is accessed responsive to data indicative of an application launch or data indicative of a travel duration range associated with a delivery service application session. In some instances, offline process 300 can generate isochrones for each respective merchant of one or more merchants associated with a particular geographic area. In some instances, offline process 300 can otherwise generate a system mapping between travel time from a merchant to various delivery zones within a geographic area.

For instance, in one embodiment, the offline process 300 can generate a set of polygons (e.g., hexagons, squares, triangles, pentagons, heptagons, octagons) associated with each respective merchant. The set of polygons associated with the merchant can be considered the merchant's delivery zone. The merchant's delivery zone can be stored in delivery zone service 245. Delivery zone service 245 can include merchant's delivery zones which can be used as a source of truth for delivery zone service 245. Delivery zone service 245 can be a generic service used to store zones that represent a geographical area in the real world. These merchant's delivery zones can be associated with a variety of merchants and services (e.g., restaurants, freight delivery services, other service providers).

The system can include a merchant manager 250 which can have an associated user interface 255. Merchant manager 250 can surface a number of merchants (e.g., restaurants) via the user interface 255. The user interface 255 can include selectable elements used for managing the candidate merchants (e.g., via input from a user associated with a delivery service or service provider).

FIG. 3 depicts the offline process 300 briefly discussed with regard to FIG. 2. Merchant's delivery zone service 240 can obtain merchant's delivery zones for candidate merchants from online storage 305. Merchant delivery zones can be generated via offline process 300. For example, a number of merchant's delivery zones can be generated for a merchant for a number of times during a day. Merchant's delivery zone generation 310 can average these merchant's delivery zones to determine a merchant's delivery zone for a merchant that will result in consistent availability of a merchant throughout a day (e.g., merchants available at lunch are generally also available at dinner). Merchant's delivery zones can be generated using a travel time between a merchant and a delivery zone.

In some implementations, the merchant's delivery zones can vary based at least in part on intent signals. For example, intent signals can include demand, courier supply, etc. If a courier supply is particularly large for a given time, one or more expanded merchant's delivery zones can be generated (or retrieved) to expand the area in which a merchant is deliverable. A merchant's delivery zone generation and deliverability determination can be determined in any reasonable manner, including any implementation, embodiment, or aspect disclosed in this description.

For instance, offline process 300 can include generating travel duration buckets for delivery zones based at least in part on the merchant's delivery zones. By way of example, offline process 300 can include merchant delivery zone generation 310, travel duration bucket generation 315, and archive 320.

In some embodiments, merchant's delivery zones can be generated on a regular interval or can be generated in response to one or more triggers. For example, merchant's delivery zones can be regenerated hourly, daily, weekly, monthly. In some examples, merchant's delivery zones can be generated in response to a trigger. For example, a trigger can include a new traffic pattern or an intent signal. A new traffic pattern can be associated with a road opening, road closure, new traffic light, etc. An intent signal can include a supply condition, weather condition, etc. For example, during warmer months (e.g., the summer) more couriers may be available or willing to perform delivery service requests. In response, merchant's delivery zones may be expanded to service a larger area associated with a longer travel time between a merchant and a particular delivery zone of the merchant's delivery zone. Additionally, or alternatively, in a time with greater traffic or worse weather, there can be an undersupply of couriers. In an instance of undersupply of couriers, merchant's delivery zones may be reduced to service a smaller area associated with shorter travel time between a merchant and a particular delivery zone of the merchant's delivery zone. Increasing or decreasing the area of the merchant's delivery zone can result in more efficient allocation of resources (e.g., via courier placement, ranking merchants and displaying those with highest likelihood of obtaining user selection).

Merchant delivery zones can be generated based at least in part on intent signals or demand signals. Demand signals can be associated with cuisine types, diversity of cuisine options for a particular delivery area, data indicative of users searching for a particular cuisine, data indicative of user searching for a particular merchant, a group of users located above a threshold distance from any merchant associated with a specific cuisine type, etc. Intent signals can include signals obtained from a shared database associated with a service provider and other services provided by the provider (e.g., rideshare service, alternative delivery services, etc.). For example, the system can obtain data indicative of a rideshare history associated with a user being dropped off or picked up from a particular restaurant. In response, the system can expand a merchant's delivery zone to include a merchant associated with a delivery zone even though the merchant would otherwise be excluded from a strictly travel time-based merchant's delivery zone model. In some embodiments, the system can determine that a merchant's delivery zone generation based at least in part on intent or demand signals can result in relocation of courier supply. This can result in an adjustment to the delegation or merchants, for example, by increasing opportunities to batch orders, create opportunities for add-on orders, or affect the generation of isochrones for merchants based at least in part on expected reallocation of courier supply.

The size of a merchant's delivery zone being increased or decreased based at least in part on a number of merchants displayed can be determined in a variety of ways. For example, an increase or decrease in merchant's delivery zone size can be made by adjusting a travel time threshold, adjusting a percentage of delivery zones (e.g., polygons, hexagons), use of an algorithm to determine an adjustment based at least in part on weighting signals, etc. For example, based at least in part on the number of positive demand signals, an increased proportion of merchants within each travel duration band can be displayed (e.g., adding more merchants from travel bands with longer travel times to the selected and ranked merchants).

In some implementations, a travel time threshold could be determined to be acceptable. For example, if there are five restaurants within 30 minutes travel time of a user location associated with Italian cuisine, a sixth Italian restaurant located 40 minutes away from the user location may not be surfaced. However, if there are no Chinese restaurants within 30 minutes of a user location, but there are intent or demand signals that indicate a user in that location is likely to initiate an order from a Chinese cuisine restaurant, it could be determined that the Chinese item or restaurant should be presented more prominently than another restaurant, even if the Chinese restaurant is further in travel duration from the delivery zone.

The merchant's delivery zone can be determined for multiple travel durations to generate travel duration buckets associated with the merchant. For instance, a first bucket can be associated with travel duration between 0 and 30 minutes, a second bucket can be associated with travel duration between 30 and 45 minutes, and a third bucket can be associated with travel duration above 60 minutes. The delivery zones associated with the respective travel duration buckets and be stored as associated with the particular travel duration from the merchant. The travel duration buckets for each merchant can be used to generate travel duration buckets for delivery zones.

As travel duration buckets for delivery zones are generated, they can be stored in archive 320. Archive 320 can include travel duration buckets of varying ranges associated with travel duration from the respective delivery zones to a number of merchants within each travel duration range. In some instances, the travel duration buckets can be stored with an identifier of origination. An identifier of origination can include a day or time stamp of generation. The archive 320 can include historical travel duration buckets (e.g., previously generated travel duration buckets) or historical merchant's delivery zones (e.g., previously generated merchant's delivery zones, prior merchant's delivery zones) as well as the most recently generated travel duration buckets for each respective delivery zone. The system can extract the most up-to-date travel duration buckets from archive 320 and send data indicative of the most up-to-date travel duration buckets to be stored in online storage 305. Travel duration bucket service 240 can access online storage 305 to obtain data indicative of travel duration buckets for the delivery zones. The system can use travel duration bucket service 240 to determine which candidate merchants should be ranked and displayed via a feed displayed on a user device.

The system can obtain data indicative of a user location that is located within a delivery zone. The travel duration buckets associated with the delivery zone can be used to determine which subgroup of candidate merchants should be selected, ranked, and displayed via a feed on the user device.

By generating travel duration buckets for a number of delivery zones including merchants that are within travel duration ranges of the delivery zones, real-time processing associated with feed display or service requests can be decreased. For example, when a user launches a service application, the service application can determine what delivery zone is associated with the user's current location (or location data obtained via user input). The delivery zone can be associated with a number of travel duration buckets which include groups of merchants that are within set travel duration ranges of the delivery zones.

The system can select a cross-bucket subset of merchants (e.g., across the number of travel duration buckets) to rank and display via a feed on a user device. In some instances, user preferences or other user data can be used to select or rank the cross-bucket subset of merchants. This can decrease the amount of processing done by the system because the system does not need to calculate a travel time between the user location (e.g., delivery zone) and merchant for each potential candidate merchant. Moreover, by generating the travel duration buckets in an offline process, the payload, the payload in the service application can be reduced by offloading and storing this data offline and making only necessary portions available online (e.g., via online storage 305).

In some instances, the travel duration buckets and associated distance between delivery zones and merchants can result in adjustments to the services. For example, delivery of an item that is further away could result in increased delivery fees, larger basket size requirements, affect which items or merchants are displayed to a user as a candidate merchant. Additionally, or alternatively, the available merchants within a travel duration bucket for a delivery zone can be adjusted based at least in part on courier supply, user demand, or restaurant specific characteristics. Restaurant specific characteristics can include at least one of cuisine type, frequency of order (e.g., how often users from a geographic area order from a specific restaurant), frequency of searches (e.g., how often users search for the restaurant), deliverability (e.g., satisfaction of distance requires, hours of operation, indication of currently accepting delivery orders), or discoverability (e.g., the store cannot provide delivery orders but can be selected for pick-up items).

FIGS. 4A-4C depict an example graphical depiction of generating merchant delivery zone pairs and travel duration buckets based at least in part on an example geographic area. For instance, FIG. 4A depicts an example geographic area 400 which can include merchants 405A-405C and delivery zones 421-426. As described herein, the delivery zones can be generated by dividing an example geographic area 400 into discrete units. In this example, the discrete units are represented as hexagons.

FIG. 4B depicts an example generation of merchant delivery zone pairs table 450. As depicted in merchant delivery zone pairs table 450, each merchant (e.g., merchant 405A-405C) can have a number of delivery zones (e.g., delivery zones 412-426) which can be traveled to within a duration associated with the merchant delivery zone pairs table 450. For instance, the merchant delivery zone pairs table 450 can be generated to map, for each respective merchant in geographic area 400, a number of delivery zones which can be reached within a set travel duration (e.g., 15-minutes, 30-minutes, 45-minutes, etc.).

Merchant delivery zone pairs table 450 can include merchant 405A which can have a first travel duration bucket including delivery zone three 423, delivery zone four 424, and delivery zone five 425. Merchant 405B can have a first travel duration bucket including delivery zone one 421, delivery zone two 422, and delivery zone four 424. Merchant 405C can have a first travel duration bucket including delivery zone four 424, delivery zone five 425, and delivery zone six 426.

FIG. 4A-4C depict an example generation of merchant delivery zone pairs and travel duration buckets associated with a single travel duration for exemplary purposes only. The present disclosure provides for generating merchant delivery zone pairs and travel duration buckets for a number of travel duration ranges such that merchant delivery zone pairs for a larger travel duration for a merchant will be inclusive of the merchant delivery zone pairs for a smaller travel duration. Additionally, or alternatively, the system can generate a number of merchant delivery zone pairs based at least in part on travel duration ranges (e.g., a list associated with travel duration of 0 to 15-minutes, a list associated with 15-minutes to 30-minutes, a list associated with 30-minutes, to 45-minutes, etc.).

The merchant delivery zone pairs table 450 can be used to generate travel duration bucket table 460 as depicted in FIG. 4C. For instance, travel duration bucket table 460 can be a reverse index of merchant delivery zone pairs table 450. As such, travel duration bucket table 460 can display a list of merchants that are within a travel duration range of each respective delivery zone. In some implementations, each delivery zone can have different groupings of merchants that are divided into travel duration buckets by travel duration ranges. For instance, a first travel duration range can be a list of merchants that are within a travel duration of 0-minutes to 15-minutes, a second travel duration range can be a list of merchants that are within a travel duration of 15-minutes to 30-minutes, and a third travel duration bucket can be a list of merchants that are within a travel duration of 30-minutes to 45-minutes. These numbers and groupings are used for exemplary purposes only.

FIG. 4C depicts an example travel duration bucket table 460 for a single travel duration range. For instance, each hexagon can represent a travel duration of 15-minutes. As such, a merchant that is located on a border of or within a delivery zone can be reached within a travel duration of 15-minutes. Thus, travel duration bucket table 460 represents for each delivery zone, the merchants which are within a travel duration of 15-minutes. As such, delivery zone one 421 can have a travel duration bucket including merchant B 405B. Delivery zone two 422 can have a travel duration bucket including merchant B 405B. Delivery zone three 423 can have a travel duration bucket including merchant A 405A. Delivery zone four 424 can have a travel duration bucket including merchant A 405A, merchant B 405B, and merchant C 405C. Delivery zone five 425 can have a travel duration bucket including merchant A 405A, merchant B 405B, and merchant C 405C. Delivery zone six 426 can have a travel duration bucket including merchant C 405C.

A full travel duration bucket table 460 can include a list of merchants that are within a number of travel duration ranges for each delivery zone. Such that, for example, in a second travel duration range bucket for delivery zone one 421, merchant 405C could be populated because it is not within a first travel duration range bucket for delivery zone one 421 which only includes merchant 405B.

Because the merchant delivery zone pairs generation and travel duration bucket generation can be completed in an offline process (e.g., offline process 300), at a merchant's onboarding time, a data structure (e.g., travel duration bucket table 460) can be updated to add the merchant into relevant delivery zone's travel duration bucket range. This provides for a searchable index of merchants for each delivery zone within the geographic area.

While FIG. 4A to FIG. 4C depict a single travel duration bucket range for a number of delivery zones, FIG. 5A and FIG. 5B will show an example of generating a number of travel duration bucket ranges for a single delivery zone.

For instance, FIG. 5A depicts an example geographic area 500 which includes a number of delivery zones 505, merchants 510A-510C, and selected delivery zone 515. For instance, example geographic area 500 can include a number of delivery zones 505, which in this example, are represented as hexagons. The delivery zones 505 can be generated using any reasonable method, and can include subdivisions of a larger geographic area such as neighborhoods, streets, blocks, coordinates, or other means of dividing a geographic area into smaller portions. Additionally, geographic area 500 can include a number of merchants. The merchants can include merchant 510A-510D. As described with regard to FIG. 4A to FIG. 4C, the system can generate a travel duration bucket including merchants that are within travel duration ranges of a delivery zone. FIG. 5B depicts an example travel duration bucket for selected delivery zone table 550 for selected delivery zone 515.

Travel duration buckets for selected delivery zone table 550 can include a number of travel duration ranges which are represented as bucket 1, bucket 2, and bucket 3. Each travel duration range can be associated with a number of merchants that can be reached from the selected delivery zone 515 within a respective travel duration (e.g., time, distance, etc.). For instance, as depicted in travel duration buckets for selected delivery zone table 550, merchant 510A and merchant 510B can be reached within a travel duration range associated with bucket 1, merchant 510D can be reached within a travel duration range associated with bucket 2, and merchant 510C can be reached within a travel duration range associated with bucket 3. Turning back to a previous example, bucket 1 can be associated with a travel duration of 0-minutes to 15-minutes, bucket 2 can be associated with a travel duration of 15-minutes to 30-minutes, and bucket 3 can be associated with a travel duration of 30-minutes to 45-minutes.

In addition to travel duration ranges, merchants can have associated stores which can be used to rank the stores within each travel duration bucket. For instance, FIG. 6A depicts an example travel duration bucket table 610 and FIG. 6B depicts an example user interface 650 with merchants that were selected and ranked for display.

Travel duration bucket table 610 can include buckets, merchants within the buckets, and scores associated with the respective merchants. The computing system (e.g., network system 130) can generate travel duration bucket table 610 as described herein. Scores for each of the respective merchants can be determined based at least in part on data associated with the merchants such as rating, cuisine type, order preparation time, conversions, or other relevant metrics. In some instances, scores can be universal across users. In some instances, scores can be personalized depending on a user profile associated with a service order session, filtering criteria, time of day, or other relevant personalization data.

Travel duration bucket table 610 can include a breakdown into buckets associated with travel durations. For instance, the buckets can include travel duration A 615A, travel duration B 615B, and travel duration C 615C. Travel duration A 615A can be associated with merchants that can be reached within a 0-minute to 15-minute range, travel duration B 615B can be associated with merchants that can be reached within a 15-minute to 30-minute range, and travel duration C 615C can be associated with merchants that can be reached within a 30-minute to 45-minute range. In some instances, the ranges can be pre-defined ranges. In some instances, the ranges can be based at least in part on dividing a maximum time into buckets of equal sizes (e.g., equivalent units of time, distance, etc.).

By way of example, a total amount of time can be 45-minutes. The computing system can generate three equal buckets of 15-minute time increments each. Additionally, or alternatively, the computing system could break the time into five, ten, or any number of buckets. Thus, in an example where a first merchant is located 4 minutes travel time and a second merchant is located 17 minutes of travel time, the first merchant would be in the first bucket and the second merchant would be in a second bucket if the buckets are broken down into 15-minute range increments.

In some implementations, associated with the travel duration buckets is a list of merchants that are located within the requisite travel duration associated with the bucket. Within the travel duration buckets, the merchants can be sorted based at least in part on a score as described herein. Upon receipt of data indicative of a service application launch or initiation of a service order request, the computing system can parse the travel duration bucket table 610 to determine a subset of merchants to provide for display via a user interface such as user interface 650 depicted in FIG. 6B.

In some implementations, the computing system can determine a subset of merchants to provide for display based at least in part on a combination of the merchant scores and travel duration buckets. For instance, the computing system can select a subset of merchants from each travel duration bucket and generate a cross-bucket subset of merchants to provide for display via user interface 650. As can be seen in FIG. 6B, user interface can include depiction of three merchants from travel duration A 615A, three merchants from travel duration B 615B, and one merchant from travel duration C. The methods used to select the subset of merchants provided for display will be discussed further with regard to FIG. 7.

FIG. 7 depicts a flowchart diagram of an example method for a data ingestion pipeline for bucketized selection, ranking, or search of merchants in a geographic area according to example embodiments of the present disclosure. One or more portion(s) of method 700 can be implemented by one or more computing devices such as, for example, the computing devices/systems described in FIGS. 1-3, 8, and 9. Moreover, one or more portion(s) of the method 700 can be implemented as an algorithm on the hardware components of the device(s) described herein (e.g., as in FIGS. 1-3, 8, and 9). For example, a computing system can include one or more processors and one or more non-transitory, computer-readable media storing instructions that are executable by the one or more processors to cause the computing system to perform operations, the operations including one or more of the operations/portions of method 700. FIG. 7 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure.

At (705), the method 700 can include accessing a data structure including a number of delivery zones, a number of merchants, and a travel duration associated with each respective delivery zone of the number of delivery zones. For instance, a computing system (e.g., an operations computing system associated with a service entity) can access a data structure including a number of delivery zones, a number of merchants, and a travel duration associated with each respective delivery zone of the number of delivery zones.

As described herein, the data structure including the number of delivery zones, the number of merchants, and the travel duration associated with each respective delivery zone of the number of delivery zones can be generated in an offline process (e.g., offline process 300). The travel duration can be determined in a number of manners. For instance, the travel duration can be a temporal distance (e.g., time) or physical distance between a merchant and a delivery zone. In some instances, the travel duration associated with the respective delivery zones can include an isochrone-based travel duration. For instance, the delivery zones can include a number of zones that can be reached within a set time period or otherwise grouped by a cutoff time that can be set by the computing system, a user, or some other policy setting entity.

In some instances, the travel duration can be a physical distance. For instance, the travel duration associated with the respective delivery zones can include a haversine distance-based travel duration. For example, the distance can be a distance between a merchant and delivery zone determined as an absolute distance (e.g., as the crow flies). Additionally, or alternatively, the travel duration associated with the respective delivery zones can be determined using a travel duration algorithm. For instance, the travel duration algorithm can determine a distance traveled to get from a merchant to a delivery zone. The travel duration algorithm can take into account more than one mode of transportation being taken for a particular route, accessibility associated with a delivery zone or merchant (e.g., parking, stairs), or other relevant data.

The travel duration can be measured from merchant to delivery zone or delivery zone to merchant. The travel duration can be estimated for different times of day, days of week, etc. and can be adjusted to take into account traffic data, travel vehicle, travel routes, holiday traveling, road closures, traffic conditions, road network information, road signs and markings, geographical data, road conditions, toll information, weather, environmental factors, construction, historical traffic data, emergency services, and more. Delivery zones can vary based at least in part on the type of merchant or services (e.g., restaurants, freight delivery services, grocery delivery, or other service providers).

A delivery zone can be a subzone within a geographical area. For instance, a map of delivery zones can be generated for a geographical area such as a city or county. The delivery zones can be determined using any means of sub-dividing a space. For instance, the delivery zones can be associated with individual coordinates or groupings of geographic coordinates, city blocks, streets, neighborhoods, polygons, or other means of dividing the geographical area into discrete subdivisions. Thus, in some instances a delivery zone can span a few inches or feet, and in other instances, a delivery zone can span a few blocks or miles. The size of the delivery zones can be determined based at least in part on characteristics of the geographic area. For instance, a densely populated city can have smaller areas of delivery zones compared to a more sparsely populated suburban area.

At (710), the method 700 can include generating an index data structure. For instance, a computing system (e.g., an operations computing system associated with a service entity) can generate an index data structure. As described herein, the index data structure can include for each delivery zone of the number of delivery zones: (i) a first travel duration bucket, (ii) a second travel duration bucket, and (iii) one or more merchants associated with the first travel duration bucket and one or more merchants associated with the second travel duration bucket. In some instances, the first travel duration bucket and the second travel duration bucket are disjoint lists of merchants (e.g., contain no overlapping merchants).

The index data structure can be generated in an offline process or online process. In some implementations, the index data structure can be generated in an offline process and accessed at a point of service application launch. Generation of the index data structure can include ingesting the data structure including the number of delivery zones, the number of merchants, and the travel duration associated with each respective delivery zone of the number of delivery zones can be generated in an offline process and sorting the data by delivery zone.

For instance, the first travel duration bucket and the second travel duration bucket can be associated with distinct travel duration ranges. An example discussion of a breakdown between travel duration ranges is described with regard to FIG. 6A. For instance, the data structure can include a table that is divided into various buckets associated with travel duration ranges. Each of the first travel duration bucket and second travel duration bucket can have one or more merchants associated with the respective buckets. The merchants associated with the respective buckets can be sorted based at least in part on a score generated by the computing system. The score can be associated with a conversion rate, a delivery radius, a user selection history data, a cuisine type, an order frequency, or a search frequency. The travel duration buckets can include disjoint sets of merchants such that a merchant in a first travel duration bucket cannot be within the second travel duration bucket. In some instances, travel duration buckets can be divided into equal duration increments (e.g., 5-minute, 10-minute, 15-minute, 30-minute increments). In some instances, the travel duration buckets can vary in duration increment (e.g., become a longer time range as the buckets are for merchants that are located further travel duration from the delivery zone such as a first bucket is 0-minutes to 15-minutes, second bucket is 15-minutes to 30-minutes and third bucket is 30-minutes to one hour). The travel duration bucket increments can vary based at least in part on density or can be determined by a model, such as a machine-learned model, to allow for adequate division of available merchants within a travel duration. For example, a city with 100 restaurants within a 15-minute travel duration of a delivery zone can be divided into smaller time duration increments compared to a sparser area that has 20 restaurants within a 15-minute travel duration and 100 restaurants within an hour travel duration.

In some implementations, the index data structure can be generated in an offline process (e.g., offline process 300). Thus, in some implementations method 700 can begin with accessing the index data structure responsive to receipt of a delivery service request.

At (715), the method 700 can include accessing data associated with a delivery service request including at least a drop-off location. For instance, a computing system (e.g., an operations computing system associated with a service entity) can access data associated with a delivery service request including at least a drop-off location. As described herein, the data associated with a service request can include a drop-off location. In some instances, the drop-off location can be determined using location-determining hardware associated with a user device (e.g., user device 125).

In some instances, the drop-off location can include a street address, GPS coordinates, or other data associated with a location to which the items of the service request should be delivered.

At (720), the method 700 can include responsive to accessing the data associated with the delivery service request: (i) determining a first delivery zone of the number of delivery zones including the drop-off location; and (ii) parsing the index data structure to determine one or more merchants in a first travel duration bucket associated with the first delivery zone and one or more merchants in a second travel duration bucket associated with the first delivery zone. For instance, responsive to accessing the data associated with the delivery service request, a computing system (e.g., an operations computing system associated with a service entity) can: (i) determine a first delivery zone of the number of delivery zones including the drop-off location; and (ii) parse the index data structure to determine one or more merchants in a first travel duration bucket associated with the first delivery zone and one or more merchants in a second travel duration bucket associated with the first delivery zone. As described herein, the first travel duration bucket and second travel duration bucket can be non-overlapping sets of merchants (e.g., disjoint sets).

As described herein, the computing system can determine a first delivery zone of the number of delivery zones that includes the drop-off location associated with the order request. For instance, looking at FIG. 5A, the system could determine that the drop-off location is within a selected delivery zone (e.g., selected delivery zone 515). The computing system can then parse the index data structure (e.g., travel duration buckets for selected delivery zone table 550, travel duration bucket table 610) to determine one or more merchants in a first travel duration bucket associated with the first delivery zone and one or more merchants in a second travel duration bucket associated with the first delivery zone. For instance, turning to FIG. 6A and FIG. 6B, the computing system can select a subset of merchants from the various travel duration buckets to provide for display via the user interface (e.g., user interface 650).

At (725), the method 700 can include selecting a cross-bucket subset of merchants including a first subset of merchants from the first travel duration bucket and a second subset of merchants from the second travel duration bucket. For instance, a computing system (e.g., an operations computing system associated with a service entity) can select a cross-bucket subset of merchants including a first subset of merchants from the first travel duration bucket and a second subset of merchants from the second travel duration bucket.

As described herein, the computing system can determine a subset of the merchants to be selected as candidate merchants. Selecting the cross-bucket subset of merchants can be based at least in part on a score associated with each respective merchant. For instance, the top X percent or number of merchants of each travel duration can be selected to be a part of the cross-bucket subset of merchants. In some instances, the number or percent of merchants of each travel duration bucket can be equal. In some instances, the number or percent of merchants of each travel duration bucket can be weighted or can vary from one travel duration bucket to the next. For instance, a travel duration bucket associated with a shortened travel duration can be allocated a large proportion of the number of merchants in the cross-bucket subset.

The score of each respective merchant of the subset of merchants can be determined based at least in part on (i) a travel duration associated with the first or second travel duration bucket associated with the respective merchant and (ii) a conversion rate of the respective merchant. For instance, within the travel duration buckets, merchants can be scored based at least in part on a number of signals such as travel duration, conversion rate, rating, cuisine type, user preferences, or other related signals.

Selecting the cross-bucket subset of merchants can include (i) selecting a first percentage of merchants of the first travel duration bucket as the first subset; (ii) selecting a second percentage of merchants of the second travel duration bucket as the second subset; and (iii) combining the first subset and second subset into the cross-bucket subset of merchants. For instance, the computing system can select a number, percentage, or proportion of merchants from the first travel duration bucket to be combined with a number, percentage, or proportion of merchants from the second travel duration bucket (e.g., as depicted in FIG. 6A and FIG. 6B).

In some instances, the computing system can use the index data structure as an additional input in a candidate merchant selection and ranking process. For instance, the present disclosure can allow for parallel processing of user queries. For instance, a user can provide a filtering criterion such as cuisine type, merchant rating, etc. and the computing system can query each respective travel duration bucket in parallel instead of searching on large data structure(s) including all of the merchants.

The present disclosure provides for technical benefits not only from reducing the amount of real-time processing required to determine estimated travel durations between delivery zones and merchants, but additionally provides increased processing speeds and reduced latency by allowing for parallel processing of queries.

At (730), the method 700 can include transmitting data including instructions that, when executed by a client device, cause the cross-bucket subset of merchants to be provided for display via an interface of the client device. For instance, a computing system (e.g., an operations computing system associated with a service entity) can transmit data including instructions that, when executed by a client device, cause the cross-bucket subset of merchants to be provided for display via an interface of the client device.

As described herein, the cross-bucket subset of merchants can be displayed via a user interface. Responsive to the display of the cross-bucket subset of merchants, a user can provide additional input such as selection of a merchant, request for available merchants within a different travel duration (e.g., a default can be merchants within 20 minutes travel duration, but the user can update that selection to 40 minutes travel duration to expand options). In some instances, the cross-bucket subset of merchants can be ranked before data associated with the merchants is transmitted to be provided for display. For instance, a merchant that has a low travel duration will not always be displayed higher or more prominently than a merchant with a higher travel duration. Additional signals associated with the merchant scores can be used to determine a rank and order to display the merchants via the user interface.

In some instances, transmitting data including instructions that, when executed by the client device, cause the cross-bucket subset of merchants to be provided for display via an interface of the client device includes providing the cross-bucket subset of merchants to be presented in an order based at least in part on a blending algorithm. The blending algorithm determines a ranking for each merchant within the cross-bucket subset of merchants and orders the merchants according to the ranking. A high ranking for a merchant can result in the merchant being displayed in a more prominent manner than a lower ranking merchant. For instance, a more prominent display can include being presented at the top of the user interface (e.g., to be seen first), being allotted a larger area of the user interface, or other means for drawing attention to, or otherwise prioritizing, the merchant.

As described herein, additional signals associated with the merchant scores can be used to determine ranking of the merchants and display characteristics (e.g., order of presentation, size, etc.). For instance, the ranking for each respective merchant of the number of merchants can be determined based at least in part on at least one of: a conversion rate, a delivery radius, a user selection history data, a cuisine type, an order frequency, or a search frequency.

A conversion rate can be associated with a number of users who have viewed or selected a merchant and completed a purchase with that merchant. For instance, a higher conversion rate can be associated with a higher number of purchases responsive to selection or viewing of a merchant menu or item listing.

A delivery radius can be associated with a delivery radius provided by a user or otherwise set as a default delivery radius associated with a user or merchant. For instance, if a drop-off location is outside a delivery radius for a merchant, the merchant can be suppressed, moved to the bottom of the list, or marked as undeliverable but discoverable (e.g., if the merchant is accepting pick-up orders).

User selection history data can be data associated with a particular user profile. For instance, user selection history can include data associated with favorite merchants, favorite items, favorite cuisine type, frequent orders, or trends based at least in part on time of day, day of week, season, or other relevant factors.

In some instances, the ranking of the merchants can be based at least in part on a universal expected demand and moderating expected demand based at least in part on prior or present order frequency or search frequency. Order frequency can include a current number of active orders associated with a merchant or a predicted number of orders associated with a merchant. The predicted number of orders associated with a merchant can be further based at least in part on search frequency and user data indicative of a likelihood of conversion to an active order opposed to simply browsing.

The present disclosure provides for a number of benefits discussed herein. In addition, the present disclosure can provide for expanded merchant selection without burdening the computing system with an addition of real-time processing. For instance, prior methods required real-time temporal distances between merchants and drop-off locations to be calculated and in order to expand a selection of merchants the entire index of merchants and temporal distances would need to be parsed. The present disclosure provides for more discrete data structures to allow for parallel processing and querying smaller numbers of data within respective travel duration buckets. This parallel processing helps to distribute computing load, reduce latency, and more efficient data access. By utilizing a multi-bucket blending strategy, collections of merchants can be more easily selected based at least in part on a combination of travel duration ranges and scores. Rather than fetching data associated with all merchants within a geographic area or range followed by ranking or scoring (e.g., all stores within an hour), the present system can break the geographic area or range into buckets and perform merchant selection out of the multiple buckets (e.g., travel duration range of 0-minutes to 30-minutes and 30-minutes to one hour). Breaking the processing into separate retrieval processes for the respective buckets can allow for decrease in latency and reduction in bottlenecking.

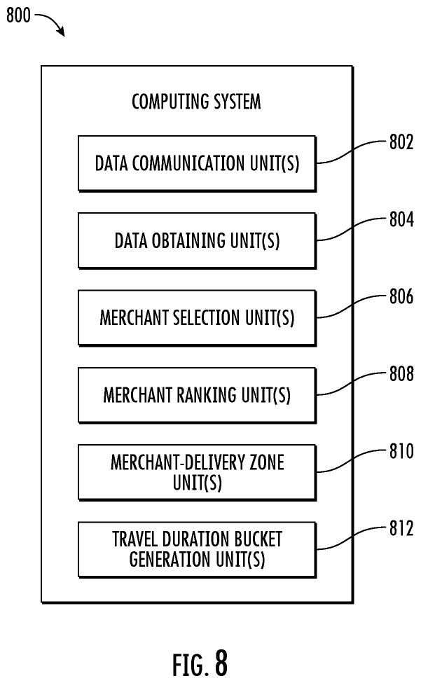

Various means can be configured to perform the methods and processes described herein. For example, FIG. 8 depicts an example computing system 800 that includes various means according to example embodiments of the present disclosure. The computing system 800 can be or otherwise include, for example, an operations computing system, etc. The computing system 800 can include data communication unit(s) 802, data obtaining unit(s) 804, merchant selection unit(s) 806, merchant ranking unit(s) 808, merchant-delivery zone unit(s) 810, travel duration bucket generation unit(s) 812, or other means for performing the operations and functions described herein. In some implementations, one or more of the units can be implemented separately. In some implementations, one or more units can be a part of or included in one or more other units. These means can include processor(s), microprocessor(s), graphics processing unit(s), logic circuit(s), dedicated circuit(s), application-specific integrated circuit(s), programmable array logic, field-programmable gate array(s), controller(s), microcontroller(s), or other suitable hardware. The means can also, or alternately, include software control means implemented with a processor or logic circuitry for example. The means can include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), or other suitable hardware.

The means can be programmed to perform one or more algorithm(s) for carrying out the operations and functions described herein. For instance, the means (e.g., data communication unit(s) 802) can be configured to communicate data indicative of a request for a courier to perform a delivery service associated with a delivery service request (e.g., an order request).

In addition, the means (e.g., data obtaining unit(s) 804) can be configured to obtain data associated with a delivery service request. For example, a delivery service request can be indicative of a pick-up location, merchant, item, or drop-off location associated with a delivery service request. In addition, in some implementations, the means (e.g., the data obtaining unit(s) 804) can obtain data associated with one or more couriers, one or more merchants, or map data indicative of one or more geographic areas.

In addition, the means (e.g., merchant selection unit(s) 806) can be configured to determine one or more selected merchants from a number of candidate merchants to display via a user interface. By way of example, the number of candidate merchants can include merchants of various categories, locations, preparation times, etc.

In addition, the means (e.g., merchant ranking unit(s) 808) can be configured to determine a ranking of selected merchants for display on a user device as recommended merchants. In addition, or alternatively, the selected merchants for display can be determined ranked based at least in part on contextual data, user data, or travel duration bucket data.

In addition, the means (e.g., merchant-delivery zone unit(s) 810) can be configured to determine merchant-delivery zone pairs and travel durations. By way of example, the merchant-delivery zone pairs can be generated based at least in part on a list of delivery zones that can be reached within travel duration ranges.

In addition, the means (e.g., travel duration bucket generation unit(s) 812) can be configured to generate or store an index data structure including a number of delivery zones and associated travel duration buckets. For instance, the travel duration buckets can include a number of candidate merchants and associated scores.

These described functions of the means are provided as examples and are not meant to be limiting. The means can be configured for performing any of the operations and functions described herein.

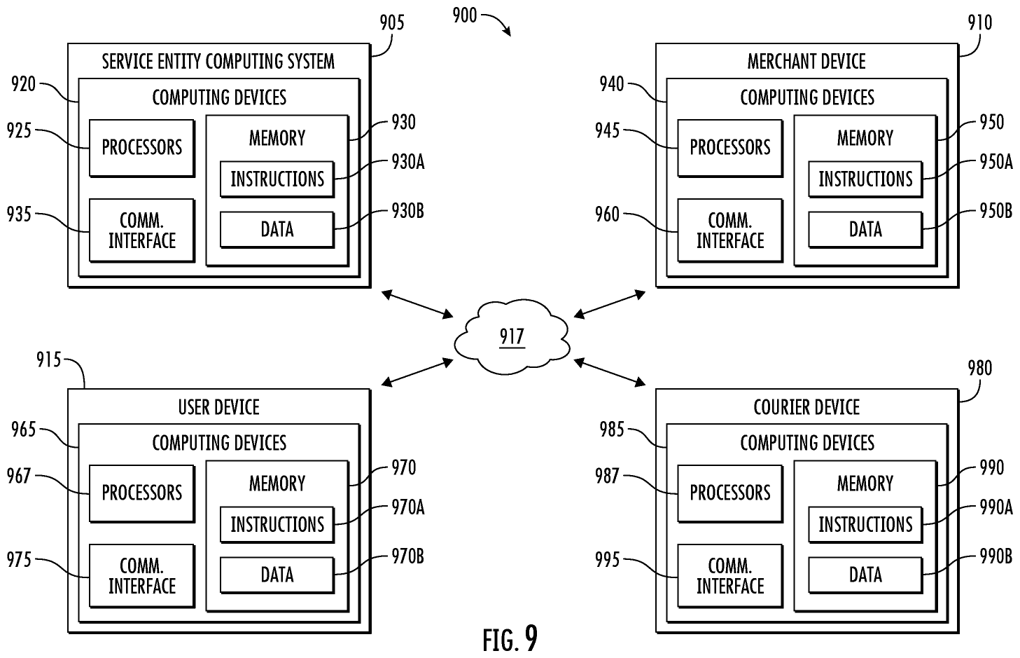

FIG. 9 depicts a block diagram of an example system 900 for implementing systems and methods according to example embodiments of the present disclosure. The example system 900 illustrated in FIG. 9 is provided as an example only. The components, systems, connections, or other aspects illustrated in FIG. 9 are optional and are provided as examples of what is possible, but not required, to implement the present disclosure. The example system 900 can include a service entity computing system 905 (e.g., that is associated with a delivery service entity). The example system 900 can include one or more merchant devices 910 (e.g., that is associated with a merchant). The example system 900 can include one or more user devices 915 (e.g., user device of the user, user device of the operator, user device of the vehicle). The example system 900 can include one or more courier devices 980 (e.g., a display device positioned on the exterior of a vehicle). One or more of the service entity computing system 905, the merchant device 910, the user device 915, or the courier device 980 can be communicatively coupled to one another over one or more communication network(s) 917. The networks 917 can correspond to any of the networks described herein.

The computing device(s) 920 of the service entity computing system 905 can include processor(s) 925 and a memory 930. The one or more processors 925 can be any suitable processing device (e.g., a processor core, a microprocessor, an ASIC, a FPGA, a controller, a microcontroller) and can be one processor or a plurality of processors that are operatively connected. The memory 930 can include one or more non-transitory computer-readable storage media, such as RAM, ROM, EEPROM, EPROM, one or more memory devices, flash memory devices, data registrar, etc., and combinations thereof.

The memory 930 can store information that can be accessed by the one or more processors 925. For example, the memory 930 (e.g., one or more non-transitory computer-readable storage mediums, memory devices) can include computer-readable instructions 930A that can be executed by the one or more processors 925. The instructions 930A can be software written in any suitable programming language or can be implemented in hardware. Additionally, or alternatively, the instructions 930A can be executed in logically or virtually separate threads on processor(s) 925.

For example, the memory 930 can store instructions 930A that when executed by the one or more processors 925 cause the one or more processors 925 (the service entity computing system 905) to perform operations such as any of the operations and functions of the computing system(s) (e.g., operations computing system) described herein (or for which the computing system(s) are configured), one or more of the operations and functions for communicating between the computing systems, one or more portions/operations of method 700, or one or more of the other operations and functions of the computing systems described herein.

The memory 930 can store data 930B that can be obtained (e.g., acquired, received, retrieved, accessed, created, stored). The data 930B can include, for example, any of the data/information described herein. In some implementations, the computing device(s) 1320 can obtain data from one or more memories that are remote from the service entity computing system 1305.

The computing device(s) 920 can also include a communication interface 935 used to communicate with one or more other system(s) remote from the service entity computing system 905, such as merchant device 910, user device 915, or courier device 980. The communication interface 935 can include any circuits, components, software, etc. for communicating via one or more networks (e.g., network(s) 917). The communication interface 935 can include, for example, one or more of a communications controller, receiver, transceiver, transmitter, port, conductors, software, or hardware for communicating data.

The merchant device 910 can include one or more computing device(s) 940 that are remote from the service entity computing system 905, the user device 915, and the courier device 980. The computing device(s) 940 can include one or more processors 945 and a memory 950. The one or more processors 945 can be any suitable processing device (e.g., a processor core, a microprocessor, an ASIC, a FPGA, a controller, a microcontroller) and can be one processor or a plurality of processors that are operatively connected. The memory 950 can include one or more tangible, non-transitory computer-readable storage media, such as RAM, ROM, EEPROM, EPROM, one or more memory devices, flash memory devices, data registrar, etc., and combinations thereof.

The memory 950 can store information that can be accessed by the one or more processors 945. For example, the memory 950 (e.g., one or more tangible, non-transitory computer-readable storage media, one or more memory devices) can include computer-readable instructions 950A that can be executed by the one or more processors 945. The instructions 950A can be software written in any suitable programming language or can be implemented in hardware. Additionally, or alternatively, the instructions 950A can be executed in logically or virtually separate threads on processor(s) 945.

For example, the memory 950 can store instructions 950A that when executed by the one or more processors 945 cause the one or more processors 945 to perform operations such as any of the operations and functions of the computing system(s) (e.g., merchant server) described herein (or for which the computing system(s) are configured), one or more of the operations and functions for communicating between computing systems, one or more portions/operations of method 700, or one or more of the other operations and functions of the computing systems described herein. The memory 950 can store data 950B that can be obtained. The data 950B can include, for example, any of the data/information described herein.

The computing device(s) 940 can also include a communication interface 960 used to communicate with one or more system(s) that are remote from the merchant device 910. The communication interface 960 can include any circuits, components, software, etc. for communicating via one or more networks (e.g., network(s) 917). The communication interface 960 can include, for example, one or more of a communications controller, receiver, transceiver, transmitter, port, conductors, software, or hardware for communicating data.

The user device 915 can include one or more computing device(s) 965 that are remote from the service entity computing system 905, the merchant device 910, and the courier device 980. The computing device(s) 965 can include one or more processors 967 and a memory 970. The one or more processors 967 can be any suitable processing device (e.g., a processor core, a microprocessor, an ASIC, a FPGA, a controller, a microcontroller) and can be one processor or a plurality of processors that are operatively connected. The memory 970 can include one or more tangible, non-transitory computer-readable storage media, such as RAM, ROM, EEPROM, EPROM, one or more memory devices, flash memory devices, data registrar, etc., and combinations thereof.

The memory 970 can store information that can be accessed by the one or more processors 967. For example, the memory 970 (e.g., one or more tangible, non-transitory computer-readable storage media, one or more memory devices) can include computer-readable instructions 970A that can be executed by the one or more processors 967. The instructions 970A can be software written in any suitable programming language or can be implemented in hardware. Additionally, or alternatively, the instructions 970A can be executed in logically or virtually separate threads on processor(s) 967.

For example, the memory 970 can store instructions 970A that when executed by the one or more processors 967 cause the one or more processors 967 to perform operations such as any of the operations and functions of the computing system(s) (e.g., user devices) described herein (or for which the user device(s) are configured), one or more of the operations and functions for communicating between systems, one or more portions/operations of method 700, or one or more of the other operations and functions of the computing systems described herein. The memory 970 can store data 970B that can be obtained. The data 970B can include, for example, any of the data/information described herein.

The computing device(s) 965 can also include a communication interface 975 used to communicate computing device/system that is remote from the user device 915, such as merchant device 910, service entity computing system 905, or courier device 980. The communication interface 975 can include any circuits, components, software, etc. for communicating via one or more networks (e.g., network(s) 917). The communication interface 975 can include, for example, one or more of a communications controller, receiver, transceiver, transmitter, port, conductors, software, or hardware for communicating data.

The computing device(s) 985 of the courier device 980 can include processor(s) 987 and a memory 990. The one or more processors 987 can be any suitable processing device (e.g., a processor core, a microprocessor, an ASIC, a FPGA, a controller, a microcontroller) and can be one processor or a plurality of processors that are operatively connected. The memory 990 can include one or more non-transitory computer-readable storage media, such as RAM, ROM, EEPROM, EPROM, one or more memory devices, flash memory devices, data registrar, etc., and combinations thereof.

The memory 990 can store information that can be accessed by the one or more processors 987. For example, the memory 990 (e.g., one or more non-transitory computer-readable storage mediums, memory devices) can include computer-readable instructions 990A that can be executed by the one or more processors 987. The instructions 990A can be software written in any suitable programming language or can be implemented in hardware. Additionally, or alternatively, the instructions 990A can be executed in logically or virtually separate threads on processor(s) 987.

For example, the memory 990 can store instructions 990A that when executed by the one or more processors 987 cause the one or more processors 987 (the courier device 980) to perform operations such as any of the operations and functions of the display device(s) described herein (or for which such devices are configured), one or more of the operations and functions for communicating between the computing systems/devices, one or more portions/operations of method 700, or one or more of the other operations and functions of the computing systems described herein.

The memory 990 can store data 990B that can be obtained (e.g., acquired, received, retrieved, accessed, created, stored). The data 990B can include, for example, any of the data/information described herein. In some implementations, the computing device(s) 985 can obtain data from one or more memories that are remote from the courier device 980.

The computing device(s) 985 can also include a communication interface 995 used to communicate with one or more other system(s) remote from the courier device 980, such as merchant device 910, user device 915, or service entity computing system 905. The communication interface 995 can include any circuits, components, software, etc. for communicating via one or more networks (e.g., network(s) 917). The communication interface 995 can include, for example, one or more of a communications controller, receiver, transceiver, transmitter, port, conductors, software, or hardware for communicating data.

The network(s) 917 can be any type of network or combination of networks that allows for communication between devices. In some implementations, the network(s) 917 can include one or more of a local area network, wide area network, the Internet, secure network, cellular network, mesh network, peer-to-peer communication link or some combination thereof and can include any number of wired or wireless links. Communication over the network(s) 917 can be accomplished, for example, via a communication interface using any type of protocol, protection scheme, encoding, format, packaging, etc.

Computing tasks discussed herein as being performed at certain computing device(s)/systems can instead be performed at another computing device/system, or vice versa. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implemented tasks or operations can be performed sequentially or in parallel. Data and instructions can be stored in a single memory device or across multiple memory devices.

The technology discussed herein makes reference to servers, databases, software applications, and other computer-based systems, as well as actions taken, and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

Aspects of the disclosure have been described in terms of illustrative implementations thereof. Numerous other implementations, modifications, or variations within the scope and spirit of the appended claims can occur to persons of ordinary skill in the art from a review of this disclosure. Any and all features in the following claims can be combined or rearranged in any way possible. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. The term “or” and “and/or” can be used interchangeably herein. Lists joined by a particular conjunction such as “or,” for example, can refer to “at least one of” or “any combination of” example elements listed therein, with “or” being understood as “and/or” unless otherwise indicated. Also, terms such as “based on” should be understood as “based at least in part on.”

Those of ordinary skill in the art, using the disclosures provided herein, will understand that the elements of any of the claims discussed herein can be adapted, rearranged, expanded, omitted, combined, or modified in various ways without deviating from the scope of the present disclosure. Some implementations are described with a reference numeral for example illustrated purposes and are not meant to be limiting.

What is claimed is:

1. A computer-implemented method, comprising:
accessing a data structure comprising a plurality of delivery zones, a plurality of merchants, and a travel duration associated with each respective delivery zone of the plurality of delivery zones;
generating, based at least in part on the accessed data structure, an index data structure comprising for each delivery zone of the plurality of delivery zones:
(i) a first travel duration bucket;
(ii) a second travel duration bucket; and
(iii) one or more merchants associated with the first travel duration bucket and one or more merchants associated with the second travel duration bucket;
accessing data associated with a delivery service request comprising at least a drop-off location;
responsive to accessing the data associated with the delivery service request:
(i) determining a first delivery zone of the plurality of delivery zones comprising the drop-off location; and
(ii) parsing the index data structure to determine one or more merchants in a first travel duration bucket associated with the first delivery zone and one or more merchants in a second travel duration bucket associated with the first delivery zone, wherein the first travel duration bucket and second travel duration bucket are non-overlapping sets of merchants;
selecting a cross-bucket subset of merchants comprising a first subset of merchants from the first travel duration bucket and a second subset of merchants from the second travel duration bucket; and
transmitting data comprising instructions that, when executed by a client device, cause the cross-bucket subset of merchants to be provided for display via an interface of the client device.

2. The computer-implemented method of claim 1, wherein transmitting data comprising instructions that, when executed by the client device, cause the cross-bucket subset of merchants to be provided for display via an interface of the client device comprises:
providing the cross-bucket subset of merchants to be presented in an order based at least in part on a blending algorithm.

3. The computer-implemented method of claim 2, wherein the blending algorithm determines a ranking for each merchant within the cross-bucket subset of merchants and orders the merchants according to the ranking, wherein a high ranking for a merchant results in the merchant being displayed in a more prominent manner than a lower ranking merchant.

4. The computer-implemented method of claim 3, wherein the ranking for each respective merchant of the plurality of merchants is determined based at least in part on at least one of: a conversion rate, a delivery radius, a user selection history data, a cuisine type, an order frequency, or a search frequency.

5. The computer-implemented method of claim 4, wherein selecting the cross-bucket subset of merchants is based at least in part on a score associated with each respective merchant.

6. The computer-implemented method of claim 5, wherein the score of each respective merchant is based at least in part on: (i) a travel duration associated with the first or second travel duration bucket associated with the respective merchant and (ii) a conversion rate of the respective merchant.

7. The computer-implemented method of claim 1, wherein the travel duration associated with the respective delivery zones comprises an isochrone-based travel duration.

8. The computer-implemented method of claim 1, wherein the travel duration associated with the respective delivery zones comprises a haversine distance-based travel duration.

9. The computer-implemented method of claim 1, wherein the travel duration associated with the respective delivery zones is determined using a travel duration algorithm.

10. The computer-implemented method of claim 1, wherein the selecting the cross-bucket subset of merchants comprises:
(i) selecting a first percentage of merchants of the first travel duration bucket as the first subset;
(ii) selecting a second percentage of merchants of the second travel duration bucket as the second subset; and
(iii) combining the first subset and second subset into the cross-bucket subset of merchants.

11. A computing system, comprising:
one or more processors; and
one or more non-transitory, computer-readable media storing instructions that are executable by the one or more processors to cause the computing system to perform operations, the operations comprising:
accessing a data structure comprising a plurality of delivery zones, a plurality of merchants, and a travel duration associated with each respective delivery zone of the plurality of delivery zones;
generating, based at least in part on the accessed data structure, an index data structure comprising for each delivery zone of the plurality of delivery zones:
(i) a first travel duration bucket;
(ii) a second travel duration bucket; and
(iii) one or more merchants associated with the first travel duration bucket and one or more merchants associated with the second travel duration bucket;
accessing data associated with a delivery service request comprising at least a drop-off location;
responsive to accessing the data associated with the delivery service request:
(i) determining a first delivery zone of the plurality of delivery zones comprising the drop-off location; and
(ii) parsing the index data structure to determine one or more merchants in a first travel duration bucket associated with the first delivery zone and one or more merchants in a second travel duration bucket associated with the first delivery zone, wherein the first travel duration bucket and second travel duration bucket are non-overlapping sets of merchants;
selecting a cross-bucket subset of merchants comprising a first subset of merchants from the first travel duration bucket and a second subset of merchants from the second travel duration bucket; and
transmitting data comprising instructions that, when executed by a client device, cause the cross-bucket subset of merchants to be provided for display via an interface of the client device.

12. The computing system of claim 11, wherein the selecting the cross-bucket subset of merchants comprises:
(i) selecting a first percentage of merchants of the first travel duration bucket as the first subset;
(ii) selecting a second percentage of merchants of the second travel duration bucket as the second subset; and
(iii) combining the first subset and second subset into the cross-bucket subset of merchants.

13. The computing system of claim 11, wherein transmitting data comprising instructions that, when executed by the client device, cause the cross-bucket subset of merchants to be provided for display via an interface of the client device comprises:
providing the cross-bucket subset of merchants to be presented in an order based at least in part on a blending algorithm.

14. The computing system of claim 13, wherein the blending algorithm determines a ranking for each merchant within the cross-bucket subset of merchants and orders the merchants according to the ranking, wherein a high ranking for a merchant results in the merchant being displayed in a more prominent manner than a lower ranking merchant.

15. The computing system of claim 14, wherein the ranking for each respective merchant of the plurality of merchants is determined based at least in part on at least one of: a conversion rate, a delivery radius, a user selection history data, a cuisine type, an order frequency, or a search frequency.

16. One or more non-transitory computer readable media storing instructions that are executable by one or more processors to perform operations comprising:
accessing a data structure comprising a plurality of delivery zones, a plurality of merchants, and a travel duration associated with each respective delivery zone of the plurality of delivery zones;
generating, based at least in part on the accessed data structure, an index data structure comprising for each delivery zone of the plurality of delivery zones:
(i) a first travel duration bucket;
(ii) a second travel duration bucket; and
(iii) one or more merchants associated with the first travel duration bucket and one or more merchants associated with the second travel duration bucket;
accessing data associated with a delivery service request comprising at least a drop-off location;
responsive to accessing the data associated with the delivery service request:
(i) determining a first delivery zone of the plurality of delivery zones comprising the drop-off location; and
(ii) parsing the index data structure to determine one or more merchants in a first travel duration bucket associated with the first delivery zone and one or more merchants in a second travel duration bucket associated with the first delivery zone, wherein the first travel duration bucket and second travel duration bucket are non-overlapping sets of merchants;
selecting a cross-bucket subset of merchants comprising a first subset of merchants from the first travel duration bucket and a second subset of merchants from the second travel duration bucket; and
transmitting data comprising instructions that, when executed by a client device, cause the cross-bucket subset of merchants to be provided for display via an interface of the client device.

17. The one or more non-transitory computer readable media of claim 16, wherein transmitting data comprising instructions that, when executed by the client device, cause the cross-bucket subset of merchants to be provided for display via an interface of the client device comprises:
providing the cross-bucket subset of merchants to be presented in an order based at least in part on a blending algorithm.

18. The one or more non-transitory computer readable media of claim 17, wherein the blending algorithm determines a ranking for each merchant within the cross-bucket subset of merchants and orders the merchants according to the ranking, wherein a high ranking for a merchant results in the merchant being displayed in a more prominent manner than a lower ranking merchant.

19. The one or more non-transitory computer readable media of claim 18, wherein the ranking for each respective merchant of the plurality of merchants is determined based at least in part on at least one of: a conversion rate, a delivery radius, a user selection history data, a cuisine type, an order frequency, or a search frequency.

20. The one or more non-transitory computer readable media of claim 16, wherein the travel duration associated with the respective delivery zones comprises an isochrone-based travel duration.
